(19) United States
(12) Patent Application Publication
(10) Pub. No.: US 2013/0105313 A1
(43) Pub. Date: May 2, 2013

(54) BIOSENSOR

(71) Applicants: Takafumi Tanaka, Ayabe-shi (JP); Hideki Tanaka, Ayabe-shi (JP); Hideki Sato, Ayabe-shi (JP)

(72) Inventors: Takafumi Tanaka, Ayabe-shi (JP); Hideki Tanaka, Ayabe-shi (JP); Hideki Sato, Ayabe-shi (JP)

(73) Assignee: GUNZE LIMITED, Ayabe-shi, Kyoto (JP)

(21) Appl. No.: 13/807,687

(22) PCT Filed: Jul. 8, 2011
(86) PCT No.: PCT/JP2011/065665

§ 371 Date: Dec. 28, 2012

(30) Foreign Application Priority Data
Jul. 12, 2010 (JP) 2010-157438
Nov. 11, 2010 (JP) 2010-252453

(51) Int. Cl. G01N 27/327

(52) U.S. Cl. CPC G01N 27/3275
USPC 204/403.02

(57) ABSTRACT

There is provided a biosensor which includes: a substrate formed of an insulator; a set of electrodes provided on the substrate; a reaction part provided on the set of electrodes; a supply port for introducing blood (a specimen) to the reaction part; an attachment part for connecting the set of electrodes to a terminal of a measurement display; and a picking plate having a picking part to be picked up, the picking plate extending to a side opposite from the attachment part with respect to the reaction part and being bent in a cross-sectional direction perpendicular to the extending direction.

### BACKGROUND OF THE INVENTION

1. Field of the Invention

The present invention relates to a biosensor that measures a specific component in a specimen.

2. Description of the Related Art

Conventionally, there has been proposed a biosensor that measures a blood sugar level or the like in a specimen (for example, Japanese Unexamined Patent Application Publication No. 2009-14394 A). With this biosensor, the blood sugar level or the like can be measured by measuring a current value between a working electrode and a counter electrode generated when a reaction part reacts to blood or the like introduced from a supply port. The biosensor is attached to a sensor attachment opening of a measurement display when measuring the blood sugar level or the like and detached from the measurement display for disposal after measurement.

The detachment of the biosensor from the measurement display after measurement has been performed by a human hand holding the biosensor, thereby exposing him/her to a risk of infection with hepatitis C, acquired immunodeficiency syndrome or the like from the blood attached to the biosensor. Therefore, the detachment of the biosensor has been performed with the utmost care by wearing gloves or the like. In addition, it is extremely difficult especially for the elderly and those who find it difficult to carry out detailed work with fingertips to attach a compact biosensor to the measurement display and detach the biosensor.

In consideration of the aforementioned problems, there has been proposed a biosensor which provides easy attachment to/detachment from the measurement display and by which blood or the like attached to the biosensor would not easily stick to a hand at the time of detachment (for example, Japanese unexamined Patent Application Publication No. 2009-14394 A).

However, as for the biosensor described in Japanese Unexamined Patent Application Publication No. 2009-14394 A, it may be more difficult for the elderly and those who find it difficult to carry out detailed work with fingertips to, when the biosensor is taken out on a table from a storage case, hold the biosensor on the table by hand and attach it to the measurement display.

As for the biosensor described in Japanese Unexamined Patent Application Publication No. 2009-14394 A, moreover, the measurement of the blood sugar level or the like requires bringing blood (a specimen) into contact with the supply port of the biosensor, the blood (the specimen) being produced from and attached to a finger (an object from which a specimen is collected) by sticking a needle thereto. However, for the elderly and those who find it difficult to carry out detailed work with fingertips, it is difficult to precisely bring the blood on the finger into contact with the small supply port, thereby possibly making the measurement of the blood sugar level even more difficult.

### SUMMARY OF THE INVENTION

In order to solve the aforementioned problems by investigating the cause thereof, the inventors have repeatedly conducted diligent research and have reached the present invention.

It is an object of the present invention to provide a biosensor which is easier to hold, easy to handle, and a manufacturing cost of which can be reduced. It is another object of the present invention to provide a biosensor that allows a specimen produced from and attached to an object from which a specimen is collected to be brought into contact with a supply port of the biosensor with ease and accuracy.

In a first preferred aspect, a biosensor according to the present invention includes: a substrate formed of an insulator; a set of electrodes provided on the substrate; a reaction part provided on the set of electrodes; a supply port for introducing a specimen to the reaction part; an attachment part for connecting the set of electrodes to a measurement display; and a picking plate which extends to a side opposite from the attachment part with respect to the reaction part and has a picking part to be picked up or on which the picking part is formed.

In the biosensor according to the present invention, the picking plate is bent or curved in a cross-sectional direction.

In the biosensor according to the present invention, at least a part of the biosensor rises from a flat surface when placed thereon. The “rise” herein refers to a rise to the degree that the biosensor can be picked up with fingers.

In the biosensor according to the present invention, the picking plate includes a fold-back line extending along a surface of the picking plate and is bent along the fold-back line.

In the biosensor according to the present invention, the supply port is located on a tip side of the picking plate relative to the fold-back line thereof and is projected outward by bending the tip side of the picking plate along the fold-back line.

In the biosensor according to the present invention, the picking plate includes a through hole, into which the supply port is projected.

In the biosensor according to the present invention, a distance from the reaction part to a tip of the picking plate is longer than a distance from the reaction part to each end of the set of electrodes on an attachment part side.

In the biosensor according to the present invention, the picking plate is engaged with an engaging member of the measurement display to be slid and detached from the measurement display by sliding the engaging member.

In another preferred aspect, the biosensor according to the present invention includes a cover for covering the reaction part, in which the picking plate is attached to the cover or the substrate.

In the biosensor according to the present invention, the set of electrodes are positioned between the substrate and the picking plate.

In still another preferred aspect, the biosensor according to the present invention includes: a substrate formed of an insulator; a set of electrodes provided on the substrate; a reaction part provided on the set of electrodes; a supply port for introducing a specimen to the reaction part; and an attachment part for connecting the set of electrodes to a measurement display. The biosensor performs measurement by bringing a specimen, which is produced from and attached to an object from which a specimen is collected, into contact with the supply port and includes a position regulating system for regulating the position of the object from which a specimen is collected with respect to the biosensor.

In a further preferred aspect, the biosensor according to the present invention includes a picking plate which extends to a side opposite from the attachment part with respect to the reaction part and has a picking part to be picked up or on which the picking part is formed. The picking plate includes a through hole into which the supply port is projected and which constitutes the position regulating system.

In the biosensor according to the present invention, the picking plate includes a fold-back line extending along a surface of the picking plate. The supply port is projected outward by bending a tip side of the picking plate along the fold-back line, and a peripheral part of the through hole forms a projected tip that is projected outward and constitutes the position regulating system.

In the biosensor according to the present invention, the supply port is located on a rear end side of the picking plate relative to the fold-back line thereof and recedes to the rear end side relative to the projected tip by bending the tip side of the picking plate along the fold-back line.

In a still further preferred aspect, the biosensor according to the present invention includes a cover for covering the reaction part, in which the picking plate is attached to the cover or the substrate.

In the biosensor according to the present invention, the set of electrodes are positioned between the substrate and the picking plate.

### ADVANTAGES OF THE INVENTION

The biosensor according to the present invention includes the picking plate which has the picking part or on which the picking part is formed, so that the picking part can be easily held by fingers when the biosensor is placed on a flat surface. As a result, the biosensor for measuring a specific component can be handled with ease. In addition, the picking plate provided for an easy grip on the biosensor allows the distance from the reaction part to the tips of the electrodes to be decreased as much as possible. As a result, the manufacturing cost can be reduced by shortening the electrodes as much as possible while allowing the biosensor to be held easily.

With the biosensor of the present invention, the position regulating system can regulate the position of the object from which a specimen is collected. For example, the specimen attached to the object from which a specimen is collected can be brought into contact with the supply port while the object from which a specimen is collected is in contact with the position regulating system. Therefore, the position regulating system supports the object from which a specimen is collected, thereby bringing the specimen produced from and attached to the object from which a specimen is collected into contact with the supply port of the biosensor with ease and accuracy.

### BRIEF DESCRIPTION OF THE DRAWINGS

FIGS. 1(a) and 1(b) are diagrams illustrating a biosensor of the present invention, where FIG. 1(a) is a plan view and FIG. 1(b) is a cross-sectional view taken along line A-A in FIG. 1(a).

FIGS. 2(a) and 2(b) are diagrams for illustrating an effect of the biosensor in FIGS. 1(a) and 1(b), where FIG. 2(a) is a cross-sectional view in which the biosensor is placed on a flat surface 28 with a picking plate 26 facing up, and FIG. 2(b) is a cross-sectional view in which the biosensor is placed on the flat surface 28 with the picking plate 26 facing down.

FIGS. 3(a) and 3(b) are diagrams for illustrating an effect of the biosensor in FIGS. 1(a) and 1(b), where FIG. 3(a) is a cross-sectional view in which the picking plate 26 is to be attached to a measurement display 22, and FIG. 3(b) is a cross-sectional view in which a supply port 20 is projected.

FIGS. 4(a) to 4(c) are diagrams enlarged into a substantially similar figure to the actual biosensor by actual dimensions, where FIGS. 4(a) and 4(b) are front views illustrating the biosensor of the present invention in FIGS. 1(a) and 1(b), and FIG. 4(c) is a front view illustrating a conventional biosensor.

FIGS. 5(a) and 5(b) are diagrams illustrating another embodiment of the biosensor of the present invention, where FIG. 5(a) is a plan view before folding back, and FIG. 5(b) is a plan view in which the biosensor is folded back.

FIGS. 6(a) and 6(b) are cross-sectional views illustrating yet another embodiment of the biosensor of the present invention.

FIG. 7(a) is a plan view illustrating yet another embodiment of the biosensor of the present invention, and FIG. 7(b) is a cross-sectional view illustrating yet another embodiment of the biosensor of the present invention.

FIGS. 8(a) to 8(c) are diagrams illustrating yet another embodiment of the biosensor of the present invention, where FIG. 8(a) is a plan view, FIG. 8(b) is a cross-sectional view, and FIG. 8(c) is a side view.

FIGS. 9(a) and 9(b) are diagrams illustrating yet another embodiment of the biosensor of the present invention, where FIG. 9(a) is a cross-sectional view before use, and FIG. 9(b) is a cross-sectional view in use.

FIG. 10 is a cross-sectional view illustrating yet another embodiment of the biosensor of the present invention.

FIG. 11 is a cross-sectional view illustrating yet another embodiment of the biosensor of the present invention.

FIGS. 12(a) and 12(b) are diagrams illustrating the biosensor of the present invention, where FIG. 12(a) is a plan view, and FIG. 12(b) is a cross-sectional view taken along line A-A in FIG. 12(a).

FIGS. 13(a) and 13(b) are diagrams for illustrating an effect of the biosensor in FIGS. 1(a) and 1(b), where FIG. 13(a) is a cross-sectional view in which the biosensor is to be attached to the measurement display 22, and FIG. 13(b) is a cross-sectional view in which the picking plate 26 is bent.

FIG. 14 is a cross-sectional view for illustrating an effect of the biosensor in FIGS. 1(a) and 1(b), where blood is brought into contact with the supply port.

FIG. 15 is a plan view for illustrating an effect of the biosensor in FIGS. 1(a) and 1(b), where blood is brought into contact with the supply port.

FIG. 16 is a plan view illustrating another embodiment of the biosensor of the present invention.

FIGS. 17(a) and 17(b) are diagrams illustrating the biosensor of the present invention, where FIG. 17(a) is a plan view, and FIG. 17(b) is a cross-sectional view taken along line A-A in FIG. 17(a).

### DESCRIPTION OF THE PREFERRED EMBODIMENTS

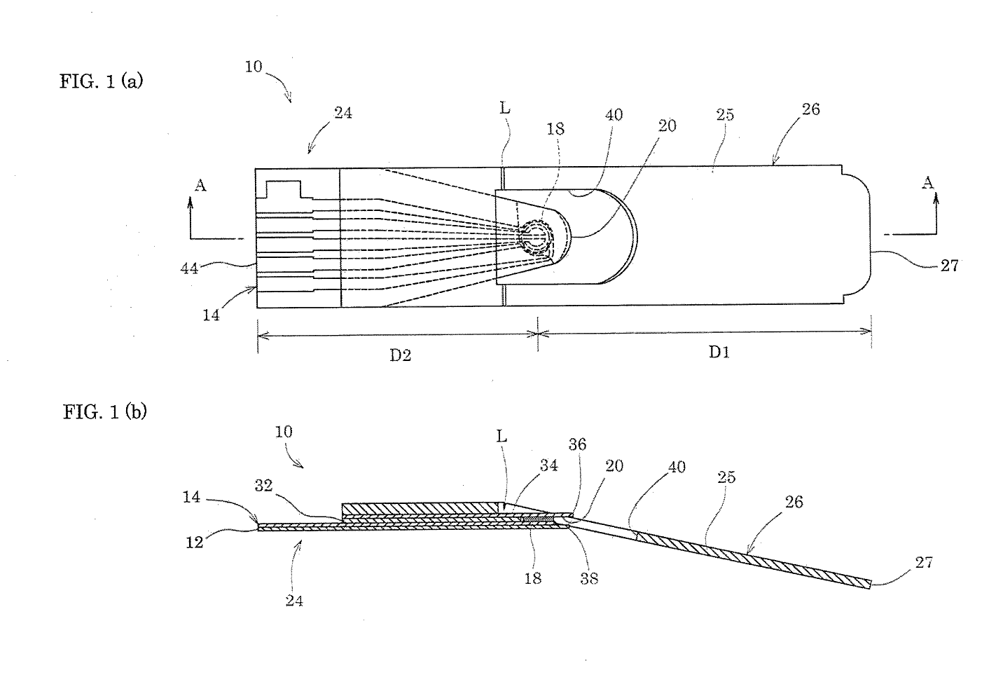

The preferred embodiments of the present invention will now be described with reference to FIGS. 1-17 of the drawings. Identical elements in the various figures are designated with the same reference numerals.

A biosensor according to the present invention will now be described in detail with reference to the drawings. A reference numeral 10 in FIGS. 1 to 3 and FIGS. 12 to 15 represents a biosensor according to the present invention.

A biosensor 10 according to the present invention includes, as illustrated in FIGS. 1(a) and 1(b): a substrate 12 formed of an insulator; a set of electrodes 14 provided on the substrate 12; a reaction part 18 provided on the set of electrodes 14; a supply port 20 for introducing blood (a specimen) to the reaction part 18; an attachment part 24 for connecting the set of electrodes 14 to a terminal of a measurement display 22; and a picking plate 26 having a picking part 25 to be picked up, the picking plate extending to a side opposite from the attachment part 24 with respect to the reaction part 18 and being bent in a cross-sectional direction perpendicular to the extending direction. Since the picking plate 26 is bent in the cross-sectional direction, at least a part of the biosensor rises from a flat surface 28 when the biosensor is placed thereon, whereby it is easily held by fingers 30.

The insulator constituting the substrate 12 may be, for example: a polyester-based resin sheet made of polyethylene terephthalate (PET), polyethylene naphthalate, a biodegradable polyester resin formed of an aliphatic unit and an aromatic unit, or the like; a plastic sheet that is more superior in heat resistance, chemical resistance, strength and the like such as a polyamide-imide sheet and a polyimide sheet; and an inorganic substrate made of ceramic or the like.

The one set of electrodes 14 include five electrode members disposed at intervals, and includes an electrode for measuring a blood sugar level, an electrode for detecting blood supply, and an electrode for detecting attachment to the measurement display 22. The configuration of the electrodes is not particularly limited as long as the blood sugar level can be measured. In addition, the set of electrodes 14 are formed of an electrode material that is a superior conductor such as platinum, gold, nickel, palladium, and indium-tin oxide. A method of forming the set of electrodes 14 is not particularly limited. However, in the biosensor 10, a conductive layer including the electrode material is formed on a surface of the substrate 12 by sputtering and subsequently formed into the shape of the electrode member by etching. Printing or hot stamping may be considered as another method of forming the set of electrodes. When the electrodes 14 are made short, more electrode members can be formed from single electrode material so that the electrode material used for the single biosensor 10 can be reduced and a cost can be reduced.

The reaction part 18 provided on the set of electrodes 14 near the tip end thereof includes oxidoreductase and an electron acceptor. For example, the reaction part is formed by applying a liquid material containing the oxidoreductase and the electron acceptor and drying the material. Glucose oxidase or glucose dehydrogenase may be used as the oxidoreductase when measuring glucose, for example. The glucose oxidase reacts with glucose to produce gluconic acid and hydrogen peroxide. The glucose dehydrogenase reacts with glucose to produce gluconolactone. Cholesterol oxidase or cholesterol esterase is used when measuring cholesterol. Alcohol oxidase or alcohol dehydrogenase is used when measuring an alcohol level. Lactate oxidase or lactate dehydrogenase is used when measuring lactic acid. Uricase is used when measuring uric acid. Moreover, the electron acceptor may be, for example, a metal salt of an alkaline ferricyanide (preferably, a metal salt of potassium ferricyanide, in particular), ferrocene or an alkyl substitute thereof, p-benzoquinone, methylene blue, potassium β-naphthoquinone-4-sulfonate, phenazine methosulfate, and 2,6-dichlorophenol-indophenol. The metal salt of an alkaline ferricyanide and the ferrocene series work stably as an electron transfer medium and dissolve well in an aqueous solvent such as water, an alcohol, or a mixed solvent thereof, thereby effectively acting as the electron acceptor.

As illustrated in FIG. 1(b), the supply port 20 is provided on the substrate 12 through a spacer 32 and is formed by a tip 36 of a cover 34 for covering the reaction part 18 and a tip 38 of the substrate 12. That is, the supply port 20 is formed by a gap created between the tip 36 and the tip 38 by the spacer 32. A specimen such as blood introduced from the supply port 20 can reach the reaction part 18 by the capillary action when sufficient amount of the specimen is introduced.

The picking plate 26 has a fold-back line L extending along the surface of the picking plate 26, which is bent along the fold-back line L. The fold-back line L is formed by an incised groove, by which the picking plate 26 is bent naturally. In place of the groove, a dotted line or a notch on the left and right sides of the biosensor 10 with respect to a long direction thereof may be provided. Moreover, the picking plate 26 includes a through hole 40 into which the supply port 20 is projected, the supply port 20 being located on a tip 27 side of the picking plate 26 from the fold-back line L thereof. As a result, the supply port 20 is projected outward by folding back the tip 27 side of the picking plate 26 along the fold-back line L, thereby allowing the blood to be attached to the supply port 20. Widths of the substrate 12, the spacer 32 and the cover 34 become narrower toward the supply port 20 side such that the supply port 20 is projected into the through hole 40. Here, the picking plate 26 is attached to the cover 34 by a double-sided tape. Although not particularly limited, a material of the picking plate 26 may be resin, paper, or the like but is preferably polyethylene terephthalate (PET) that is easy to fold back. The coloring of the biosensor according to the present invention is not particularly limited. In the case of the biosensor 10, the substrate 12 has a white color and the picking plate 26 is semitransparent, so that the picking plate 26 to be picked by a hand can be distinguished from the substrate 12 that is not to be picked up.

Moreover, a distance D1 from the reaction part 18 to the tip 27 of the picking plate 26 is longer than a distance D2 from the reaction part 18 to each end 44 of the electrodes 14 on an attachment part side, so that the costly electrodes 14 can be shortened as much as possible while allowing the biosensor 10 to be held easily. The picking plate 26 is attached to the cover 34 for covering the reaction part 18, and the set of electrodes 14 are positioned between the substrate 12 and the picking plate 26.

A mechanism of measuring the blood sugar level by the biosensor 10 of the present invention will now be described.

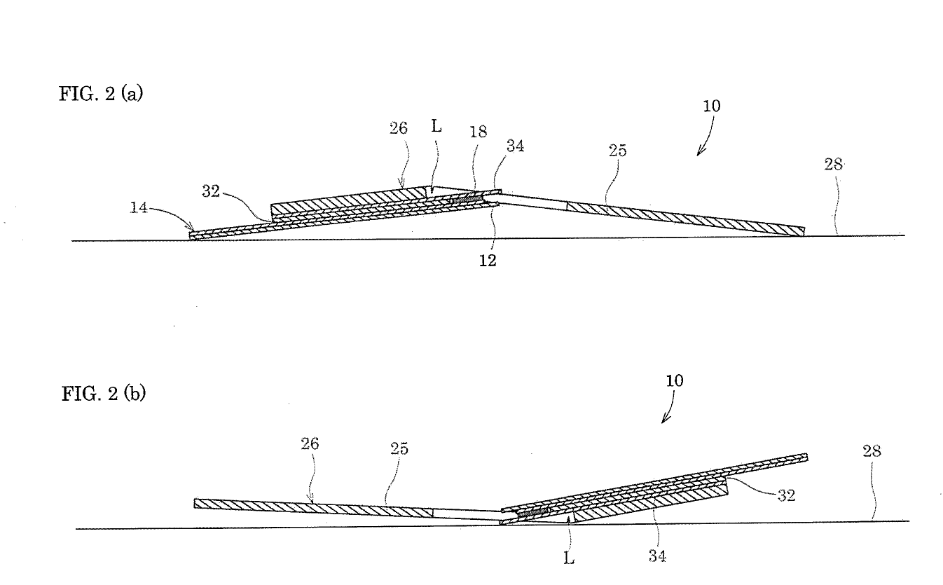

The biosensor 10 according to the present invention is stored in a storage case when purchased and is removed therefrom to be placed on a table or the like when used. For example, as illustrated in FIGS. 2(a) and 2(b), the biosensor is placed on a flat surface 28 of a table. When the biosensor is placed with the picking plate 26 facing up as illustrated in FIG. 2(a), the central area of the biosensor 10 rises up from the flat surface 28 since the picking plate 26 is bent in a cross-sectional direction. On the other hand, when the biosensor is placed with the picking plate 26 facing down as illustrated in FIG. 2(b), one or both ends of the biosensor 10 rise(s) up from the flat surface 28 since the picking plate 26 is bent in the cross-sectional direction. In either case, the biosensor can be easily held by picking up the raised picking part 25 with the fingers 30 even when the biosensor 10 is used by the elderly or those who find it difficult to carry out detailed work with fingertips. Moreover, the biosensor can be easily taken out of the storage case by picking up the picking part 25 when it is stored in the storage case with the tip 27 side of the picking plate 26 facing up. Furthermore, the biosensor can be taken out of the storage case more easily by picking up the picking part 25 by constructing the length of the picking plate 26 such that the picking part 25 is positioned in the vicinity of an opening of the storage case.

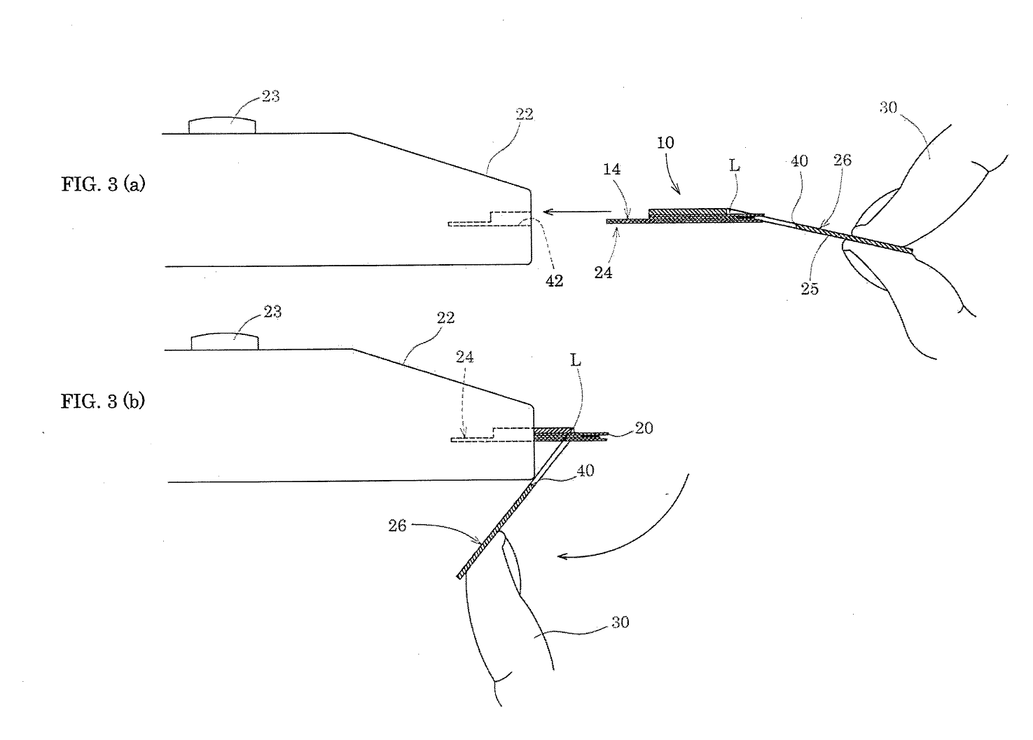

As illustrated in FIG. 3(a), the biosensor 10 thus picked up and held by the fingers 30 at the picking plate 26 is inserted into an attachment port 42 of the measurement display 22 so that a set of electrodes 14 are connected to a terminal (not shown) in the measurement display 22. Then, as illustrated in FIG. 3(b), the vicinity of the tip 27 of the picking plate 26 is pressed by the finger 30 so that the biosensor 10 is folded back along the fold-back line L. The supply port 20 of the biosensor 10 is projected outward as the biosensor is folded back along the fold-back line L, whereby the blood that comes out of the finger by sticking a needle thereto is attached to the supply port 20 for measuring the blood sugar level. After the blood sugar level is measured, the biosensor 10 is detached from the measurement display 22 either by being pressed into a direction opposite from the inserting direction by an engaging member (not shown) in the measurement display 22 by sliding an eject lever 23 with the finger 30, or by picking up the picking plate 26 by the fingers 30. The biosensor would then be discarded.

As for such biosensor 10 including the picking plate 26 bent in the cross-sectional direction, the biosensor 10 as a whole is bent so that at least a part thereof rises up from the flat surface 28 when being placed thereon. Accordingly, the biosensor can be easily held by the fingers 30.

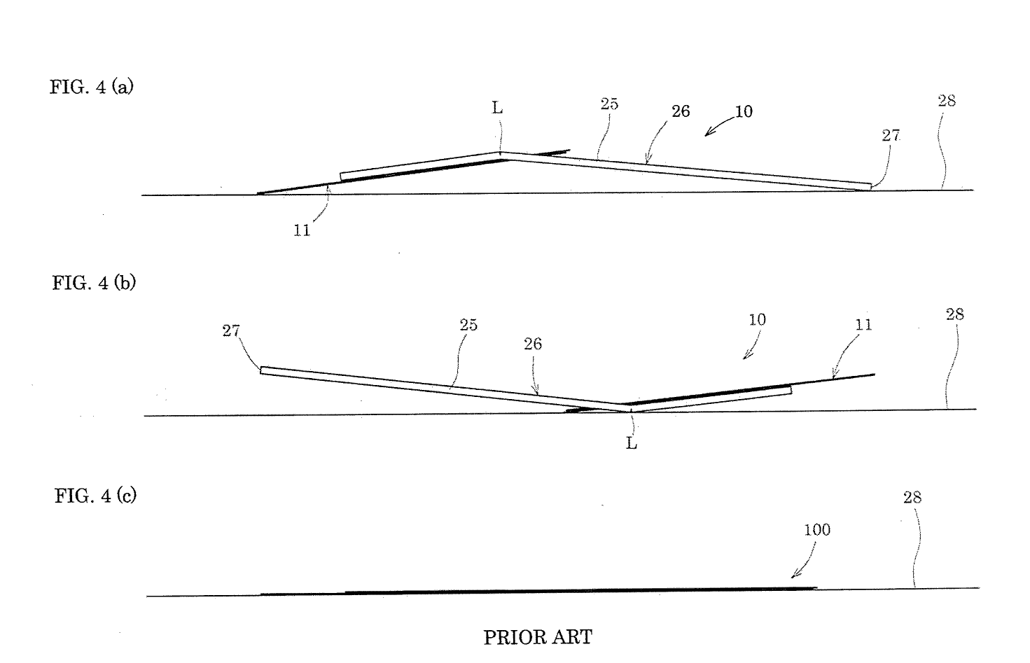

The biosensor 10 is exaggerated and enlarged in a thickness direction thereof in FIGS. 1 to 3 in order to show the positional relationship between the substrate 12 and the cover 34. In this case, the biosensor 10 of the present invention illustrated in FIGS. 4(a) and 4(b) as well as a conventional biosensor 100 illustrated in FIG. 4(c) are views in which the biosensor of actual dimensions is enlarged into a substantially similar figure. As illustrated in FIG. 4(c), the thin conventional biosensor 100 including a substrate, electrodes, a reaction part, a spacer, and a cover is in close contact with the flat surface 28 in a substantially flush state therewith. It is thus extremely difficult to hold the biosensor 100 by the fingers 30. On the other hand, as illustrated in FIGS. 4(a) and 4(b), a sensor body 11 including the substrate 12, the electrodes 14, the reaction part 18, the spacer 32 and the cover 34 of the biosensor 100 of the present invention is also a thin plate. Being provided with the picking plate 26, however, at least a part of the biosensor 10 rises up from the flat surface 28 so that it can be easily held by the fingers 30 by picking up the part that is raised.

Moreover, the biosensor 10 is bent along the fold-back line L and thus can be easily folded back therealong by simply being pressed by the finger 30 so that the supply port 20 is projected outward. Moreover, the electrodes 14 would not be damaged when the biosensor 10 is folded back because the picking plate 26, in stead of the substrate 12 on which the electrodes 14 are provided, is folded back. Since the picking plate 26 is attached to the cover 34, moreover, the biosensor 10 can be formed by varying, as appropriate, the shape of the picking plate 26 alone into a shape that can be held easily by, for example, increasing the thickness.

Moreover, as for the biosensor 10 of the present invention, the distance D2 from the reaction part 18 to an end 44 of an electrode 14 on the attachment part side can be shortened as much as possible owing to the picking plate 26 provided for holding the biosensor 10 easily. As a result, the manufacturing cost can be reduced by shortening the electrodes 14 as much as possible while making the biosensor 10 easy to hold. In particular, the manufacturing cost can be reduced by making the distance D1 from the reaction part 18 to the tip 27 of the picking plate 26 longer than the distance D2 from the reaction part 18 to each end 44 of the electrodes 14 on the attachment part side.

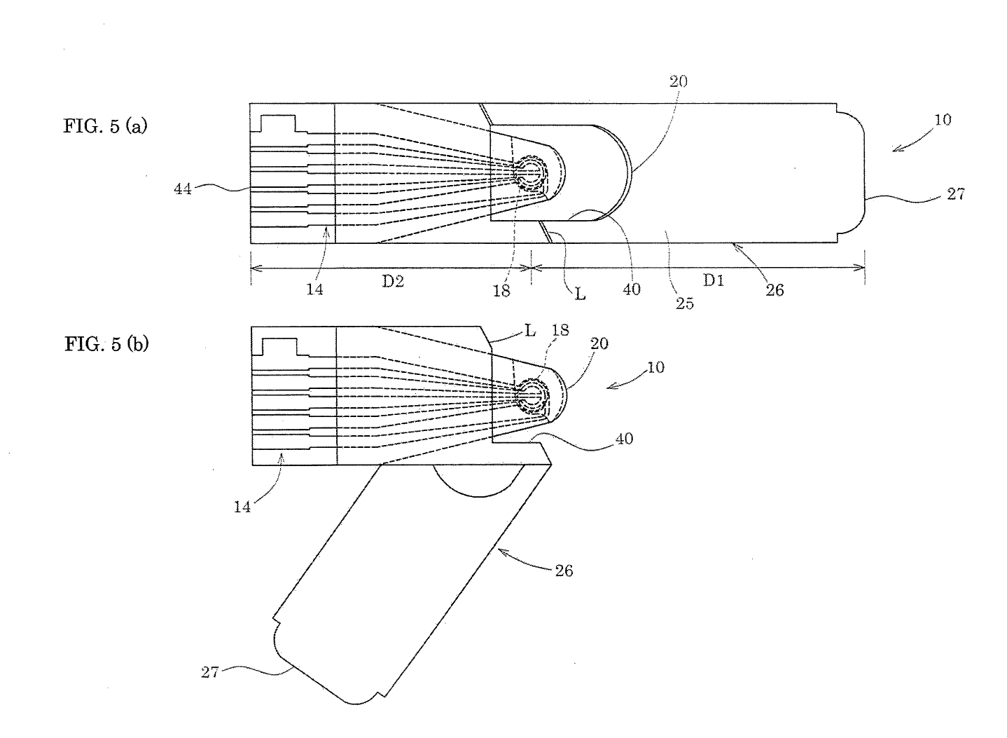

One embodiment of the present invention has been described above; however, the present invention can also be implemented by another aspect. For example, by forming a fold-back line L on the picking plate 26 in an oblique direction, the biosensor 10 of the present invention may be bent in the cross-sectional direction in oblique relation to the direction into which the picking plate 26 extends toward the tip 27, as illustrated in FIGS. 5(a) and 5(b). Even when the fold-back line L is formed in the oblique direction, the blood can be attached to the supply port 20 as long as the supply port 20 is projected outward by folding back the picking plate 26 as illustrated in FIG. 5(b).

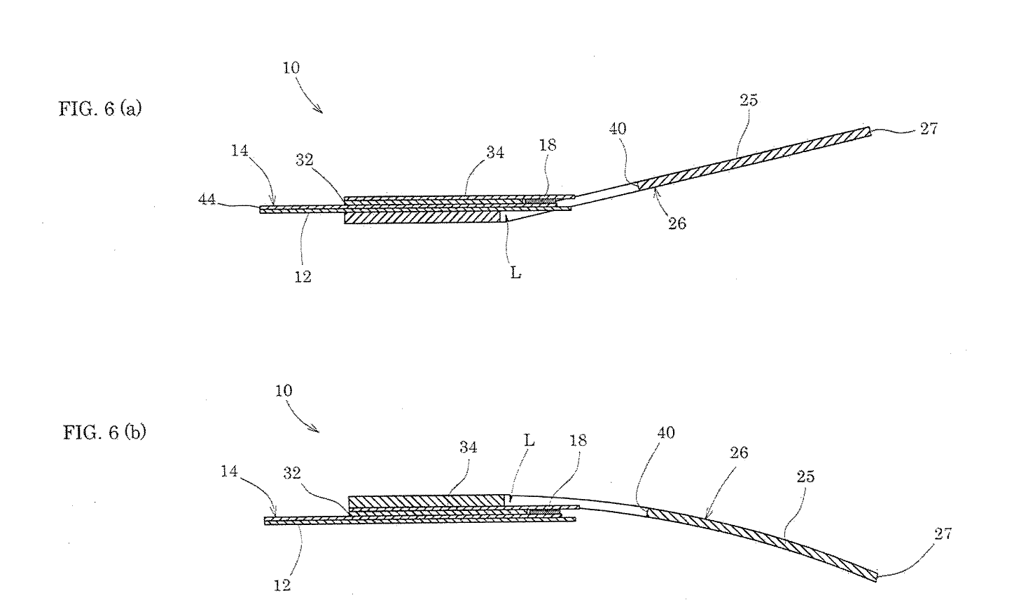

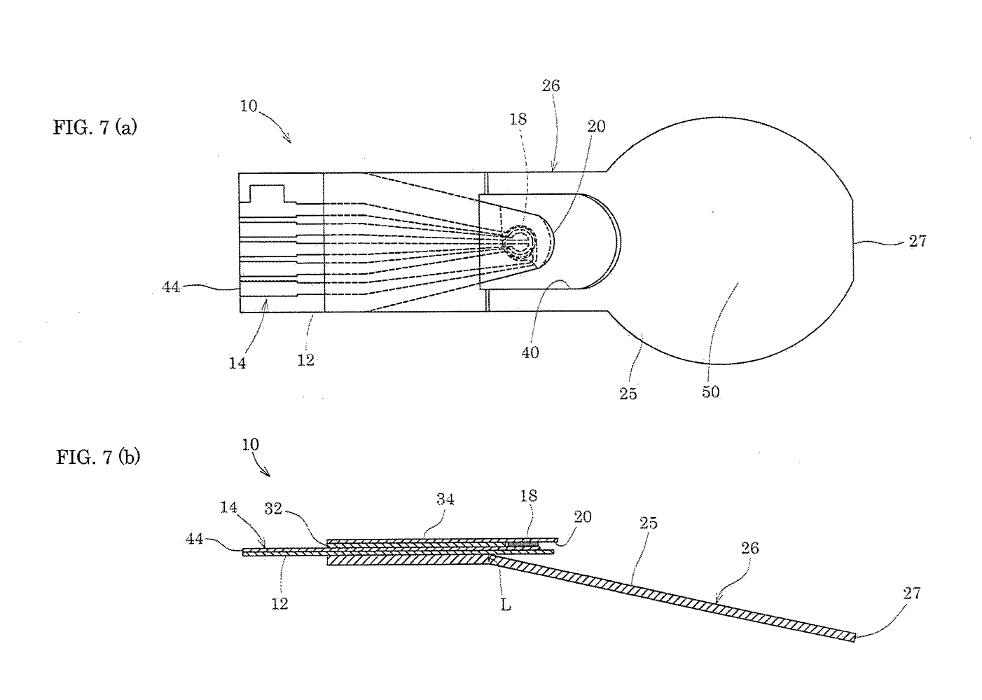

Moreover, as illustrated in FIG. 6(a), the biosensor 10 of the present invention may be bent in the direction opposite from the direction shown in FIG. 1(b) by attaching the picking plate 26 not to the cover 34 but to the substrate 12. In the biosensor 10, the picking plate 26 may also be curved as illustrated in FIG. 6(b) instead of being bent. On the other hand, as illustrated in FIG. 7(a), a grip part 50 to be picked up by the fingers 30 may be proactively provided on the tip 27 side of the picking plate 26. Moreover, as illustrated in FIG. 7(b), the picking plate 26 may be attached to the substrate 12 with no through hole 40 being provided. Even when the through hole 40 is not provided, the blood can be attached to the supply port 20 as long as the supply port 20 is projected outward by folding back the picking plate 26 along the fold-back line L.

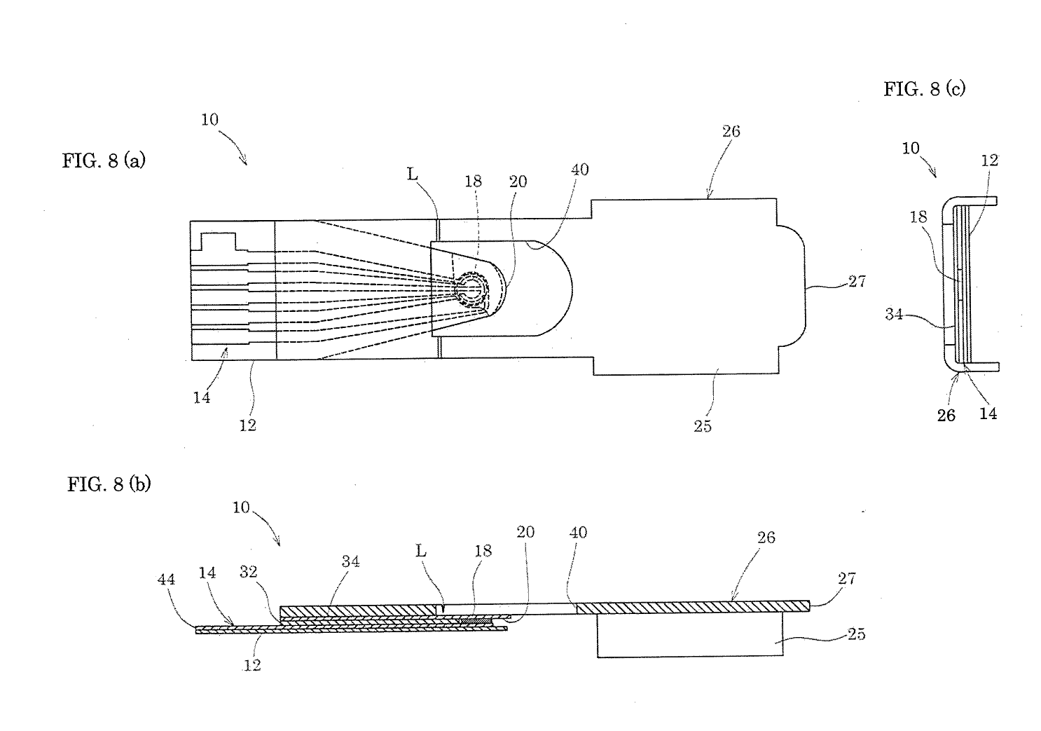

Furthermore, in the biosensor 10, the picking plate 26 may be bent in the cross-sectional direction perpendicular to the direction into which the picking plate 26 extends toward the tip 27 instead of being bent along the fold-back line L, as illustrated in FIGS. 8(a) to 8(c). In this case, at least a part of the biosensor rises up from the flat surface 28 as well when being placed thereon.

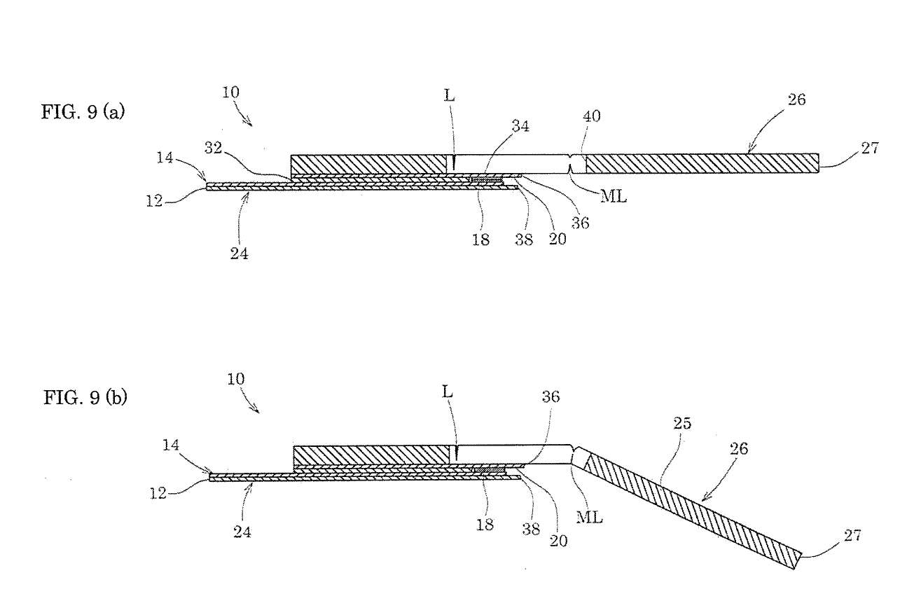

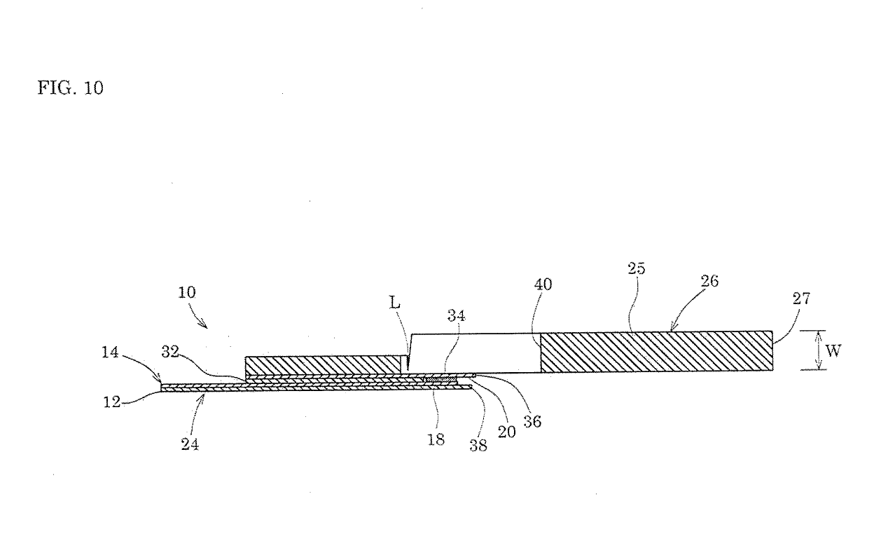

In the biosensor 10 of the present invention, the picking plate 26 does not need to be bent or curved before use. For example, as illustrated in FIG. 9(a), the picking plate 26 may be constructed into a flat plate and, when the biosensor is to be used, the picking part 25 may be formed by bending the picking plate along a folding line ML, as illustrated in FIG. 9(b). Even when the folding line ML is not provided, the biosensor can be picked up by the fingers 30 easily as long as the picking part 25 is formed with a part of the biosensor being raised. Moreover, as illustrated in FIG. 10, the picking plate 26 may include the picking part 25 thick enough to be picked up by the fingers 30 instead of being bent, curved, as well as being constructed to be bent.

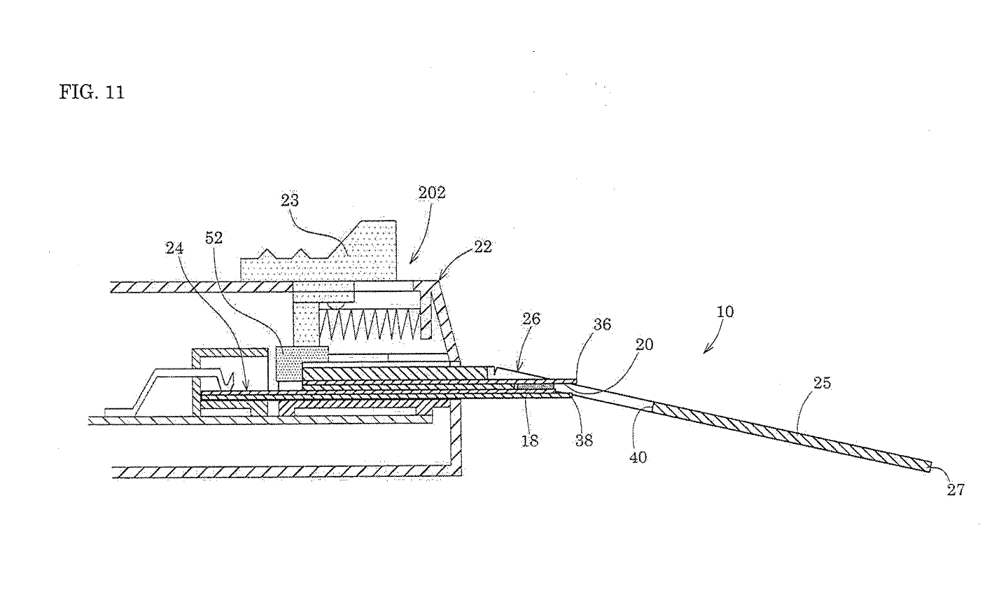

Furthermore, in the biosensor 10 of the present invention, the picking plate 26 may be used to detach the biosensor 10 from the measurement display 22 by means of a sensor ejecting mechanism 50. For example, as illustrated in FIG. 11, the biosensor 10 may be detached from the measurement display 22 by engaging the picking plate 26 with an engaging member 52 of the measurement display 22 and sliding the picking plate 26 by sliding an eject lever 23 and the engaging member 52. In this case, the picking plate 26 not only functions as a part to be held by the fingers 30 easily but also a member to be engaged for detaching the biosensor 10.

The present invention can also be implemented by an aspect not shown. For example, in addition to the construction in which the picking plate 26 is folded back at the time of measurement, the biosensor may be constructed such that the picking plate 26 is isolated by being attached to the cover 34 or the like by an adhesive having low adhesive force. Moreover, the cover 34 may include a picking part, or the picking part may be formed by the cover 34. That is, the cover 34 may also be used as the picking plate 26.

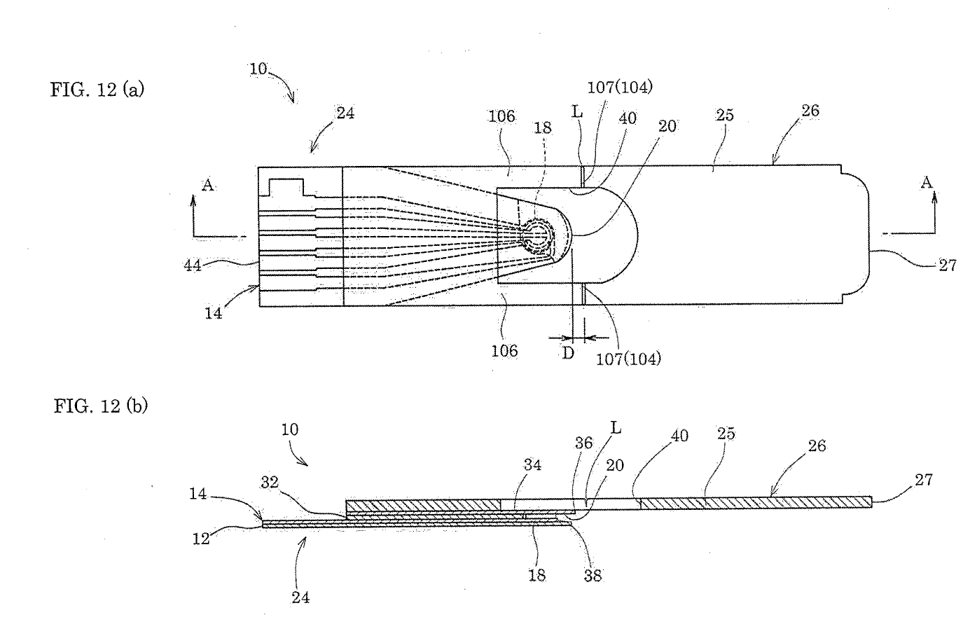

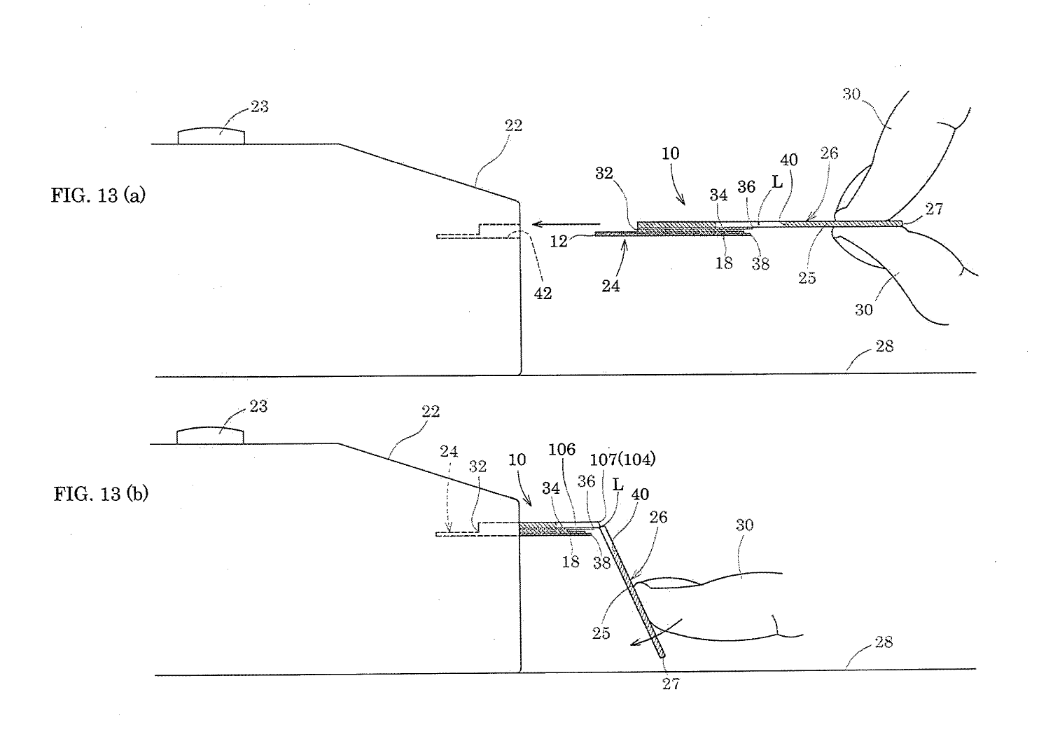

Moreover, the biosensor 10 according to the present invention illustrated in FIGS. 12(a) and 12(b) includes: a substrate 12 formed of an insulator; a set of electrodes 14 provided on the substrate 12; a reaction part 18 provided on the set of electrodes 14; a supply port 20 for introducing blood (a specimen) 100 to the reaction part 18; and an attachment part 24 for connecting the set of electrodes 14 to a terminal of a measurement display 22. The biosensor performs measurement by bringing the blood 100, which is produced from and attached to a finger (an object from which a specimen is collected) 30 illustrated in FIGS. 13(a) and 13(b), into contact with the supply port 20 and includes a position regulating system 104 for regulating the position of the finger 30 with respect to the supply port 20. The biosensor 10 is exaggerated and enlarged in the thickness direction thereof in FIGS. 12 to 14 so as to show the positional relationship between the substrate 12 and a cover 34.

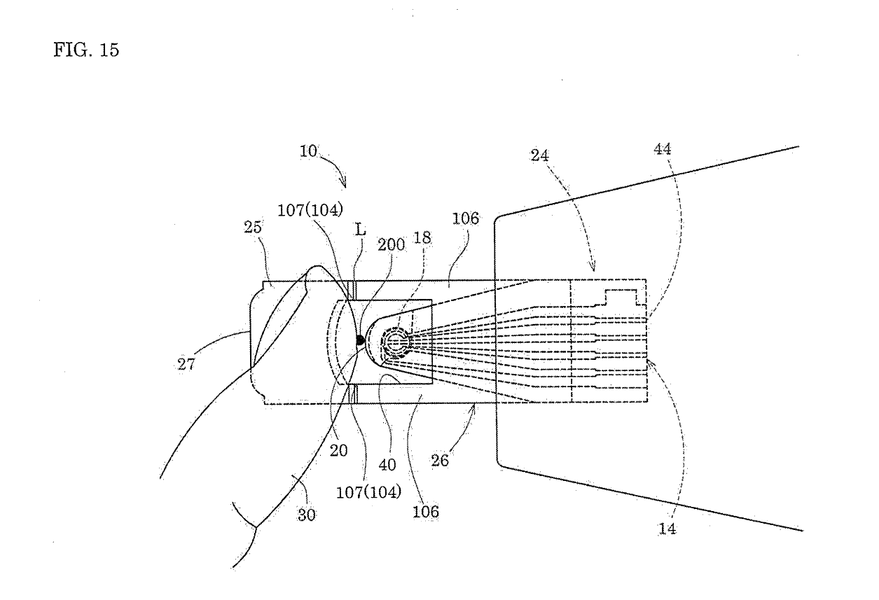

The biosensor 10 includes a picking plate 26 which extends to a side opposite from the attachment part 24 with respect to the reaction part 18 and which has a picking part 25 to be picked up. The picking plate 26 includes a through hole 40 into which the supply port 20 is projected. The picking plate 26 includes a fold-back line L extending along a surface of the picking plate 26. As illustrated in FIG. 15, the supply port 20 is projected outward by bending a tip 27 side of the picking plate 26 along the fold-back line L, and a peripheral part 106 of the through hole 40 forms a projected tip 107 that is projected outward and constitutes the position regulating system 104.

Moreover, as illustrated in FIG. 12(a), the supply port 20 is located on a rear end 44 side of the picking plate 26 relative to the fold-back line L thereof and recedes to the rear end 44 side relative to the projected tip 107 by a distance D by bending the tip 27 side of the picking plate 26 along the fold-back line L. As a result, the position of the finger 30 with respect to the supply port 20 can be regulated while bringing the blood 100 attached to the finger 30 into contact with the supply port 20 in accordance with the curvature of the tip of the finger 30 illustrated in FIGS. 13(a) and 13(b). The picking plate 26 is attached to the cover 34 for covering the reaction part 18, and the electrodes 14 are positioned between the substrate 12 and the picking plate 26.

The insulator constituting the substrate 12, the set of electrodes 14, the reaction part 18, and the supply port 20 of the biosensor 10 according to the present invention illustrated in FIGS. 12(a) and 12(b) have the identical structures to those of the biosensor 10 illustrated in FIGS. 1(a) and 1(b).

The fold-back line L on the picking plate 26 is formed by an incised groove. In place of the groove, a dotted line or a notch on the left and right sides of the biosensor 10 with respect to a long direction thereof may be provided. Moreover, the picking plate 26 includes the through hole 40 into which the supply port 20 is projected, the supply port 20 being located on the tip 27 side of the picking plate 26 from the fold-back line L thereof. As a result, the supply port 20 is projected outward by folding back the tip 27 side of the picking plate 26 along the fold-back line L, thereby allowing the blood to be attached to the supply port 20. Widths of the substrate 12, a spacer 32 and the cover 34 become narrower toward the supply port 20 side such that the supply port 20 is projected into the through hole 40. Here, the picking plate 26 is attached to the cover 34 by a double-sided tape. Although not particularly limited, the material of the picking plate 26 may be resin, paper, or the like but is preferably polyethylene terephthalate (PET) that is easy to fold back. The coloring of the biosensor according to the present invention is not particularly limited. In the case of the biosensor 10, the substrate 12 has a white color and the picking plate 26 is semitransparent, so that the picking plate 26 to be picked by a hand can be distinguished from the substrate 12 that is not to be picked up.

A mechanism of measuring the blood sugar level by the biosensor 10 of the present invention will now be described.

The biosensor 10 according to the present invention is stored in a storage case when purchased and is removed therefrom to be placed on a flat surface 28 of a table or the like when used. The biosensor 10 placed on the flat surface 28 of the table or the like is picked up and held by the fingers 30 at the picking plate 26 and is inserted into an attachment port 42 of the measurement display 22 placed on the flat surface 28 of the table so that the set of electrodes 14 are connected to the terminal (not shown) in the measurement display 22. Then, as illustrated in FIG. 13(b), the vicinity of the tip 27 of the picking plate 26 is pressed by the finger 30 so that the biosensor 10 is folded back along the fold-back line L.

The supply port 20 of the biosensor 10 is projected outward as the biosensor is folded back along the fold-back line L. At this time, the peripheral part 106 of the through hole 40 forms the projected tip 107 that is projected outward and constitutes the position regulating system 104.

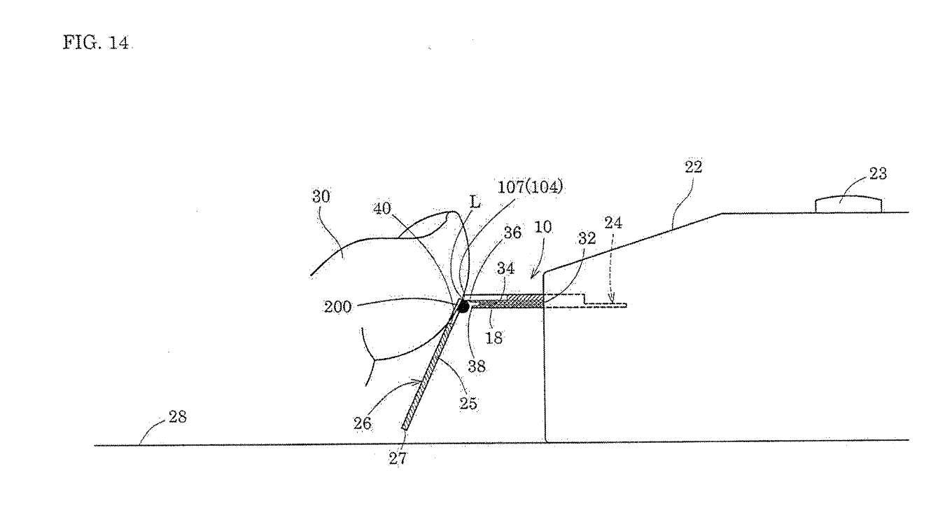

Then, the finger 30 of a person whose blood sugar level is to be measured is stuck with a needle, causing the finger 30 to bleed with the blood 100 adhered thereto. The finger 30 with the blood 100 adhered thereto is held roughly sideways to be slid nearly upward along the picking plate 26 and brought closer to the supply port 20. Then, as illustrated in FIGS. 14 and 15, the finger 30 is stopped where the blood 100 is in contact with the supply port 20.

At this time, the position of the finger 30 is regulated by the projected tip 107. In particular, the supply port 20 recedes to the rear end 44 side relative to the peripheral part 106 of the through hole 40 by the distance D, thereby allowing the blood 100 adhered to the finger 30 to come into contact with the supply port 20 while the finger 30 is in contact with the projected tip 107. Accordingly, by the projected tip 107 supporting the finger 30, the blood 100 can be brought into contact with the supply port 20 of the biosensor 10 with ease and accuracy. Moreover, there would be no damage around the supply port 20 of the biosensor 10 that can be caused by the pressing force excessively applied to the supply port 20 of the biosensor 10 by the finger 30.

The blood sugar level is measured once the blood 100 is attached to the supply port 20 in the above manner. After the blood sugar level is measured, the biosensor 10 is detached from the measurement display 22 either by being pressed into a direction opposite from the inserting direction by an engaging member (not shown) in the measurement display 22 by sliding the eject lever 23 with the finger 30, or by picking up the picking plate 26 by the finger 30. The biosensor would then be discarded.

As for the biosensor 10 of the present invention, the projected tip 107 constitutes the position regulating system 104 for regulating the position of the finger 30 that is the object from which a specimen is collected, so that the blood 100 can be brought into contact with the supply port 20 of the biosensor 10 with ease and accuracy. Moreover, the electrodes 14 would not be damaged when the biosensor 10 is folded back because the picking plate 26, instead of the substrate 12 on which the electrodes 14 are provided, is folded back. Moreover, since the picking plate 26 is attached to the cover 34, the biosensor 10 can be formed by varying, as appropriate, the shape of the picking plate 26 alone into a shape that can be held easily by, for example, increasing the thickness.

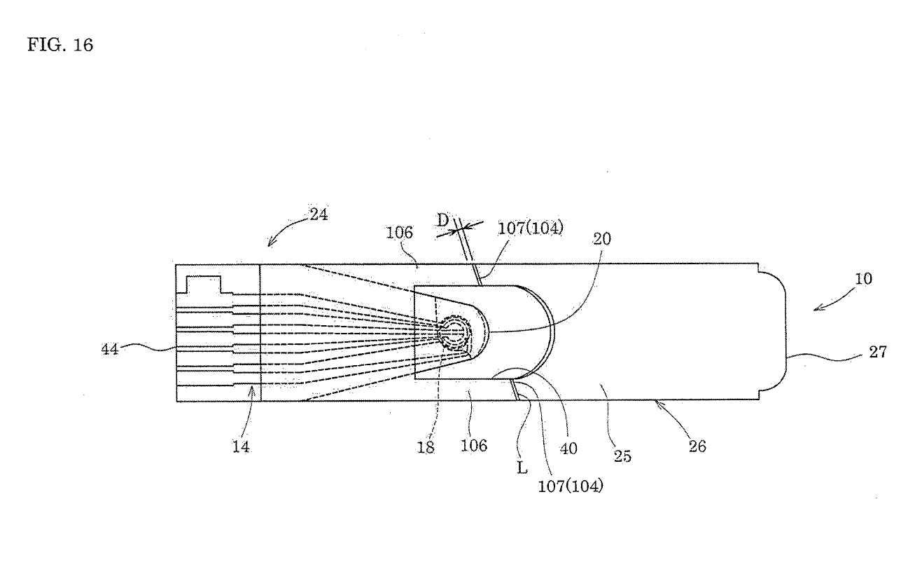

One embodiment of the present invention has been described above, however, the present invention can also be implemented by another aspect. For example, by forming the fold-back line L on the picking plate 26 in the oblique direction, the biosensor 10 of the present invention may be bent in the cross-sectional direction in oblique relation to the direction into which the picking plate 26 extends toward the tip 27, as illustrated in FIG. 16. Even when the fold-back line L is formed in the oblique direction, the supply port 20 is projected outward and the peripheral part 106 of the through hole 40 forms the projected tip 107 that is projected outward and constitutes the position regulating system 104, by folding the tip 27 side of the picking plate 26 along the fold-back line L. Moreover, the supply port 20 is located on the rear end 44 side of the picking plate 26 relative to the fold-back line L thereof and recedes to the rear end 44 side relative to the projected tip 107 by the distance D by bending the tip 27 side of the picking plate 26 along the fold-back line L. As a result, the position of the finger 30 with respect to the supply port 20 can be regulated while bringing the blood 100 adhered to the finger 30 into contact with the supply port 20 in accordance with the curvature of the tip of the finger 30.

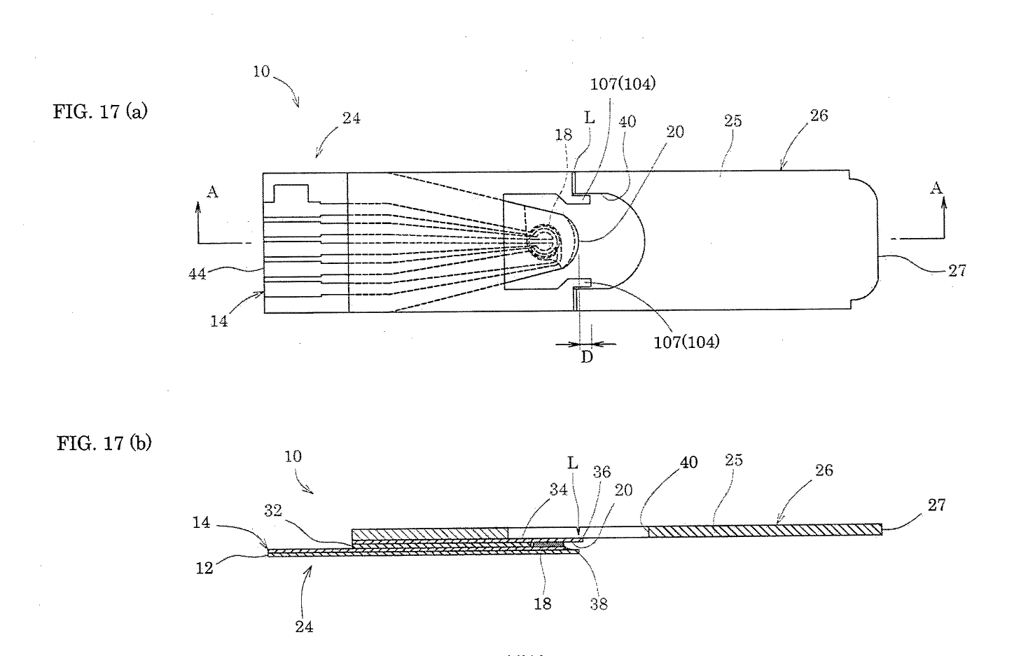

Moreover, in the biosensor 10 of the present invention, the projected tip 107 that forms the position regulating system 104 may be provided separately from the fold-back line L as illustrated in FIG. 17(a). In this case, the projected tip 107 is separated from the through hole 40. Even in such a construction, the supply port 20 is projected outward as well as the projected tip 107 is projected outward to constitute the position regulating system 104 by folding the tip 27 side of the picking plate 26 along the fold-back line L.

The technical scope of the present invention also includes an aspect to which various improvements, amendments and variations are added on the basis of the knowledge of those skilled in the art without departing from the spirit of the present invention. Moreover, the present invention may be carried out in an embodiment in which any of the invention-specifying matters is substituted by another technology within the scope that generates the same function and effect.

### INDUSTRIAL APPLICABILITY

With the biosensor of the present invention, the picking plate allows the biosensor to be easily held by the fingers, the electrodes to be shortened as much as possible, and thus the manufacturing cost to be reduced. As a result, the biosensor can be widely used for measuring a blood sugar level or the like.

With the biosensor of the present invention, the position regulating system allows the specimen produced from and attached to the object from which a specimen is collected to be brought into contact with the supply port of the biosensor with ease and accuracy. As a result, the biosensor can be widely used for measuring the blood sugar level or the like.

### EXPLANATION OF REFERENCE NUMERALS

10: biosensor; 12: substrate; 14: electrode; 18: reaction part; 20: supply port; 22: measurement display; 23: eject lever; 24: attachment part; 26: picking plate; 28: flat surface; 30: finger; 32: spacer; 34: cover; 40: through hole; 42: attachment port; 44: one end on attachment part side (rear end); 107: projected tip; 104: position regulating system; 50: sensor ejecting mechanism; 52: engaging member; L: fold-back line; ML: folding line

1. A biosensor for performing measurement by bringing a specimen, which is produced from and attached to an object from which a specimen is collected, into contact with a supply port, the biosensor comprising:
a substrate formed of an insulator;
a set of electrodes provided on the substrate;
a reaction part provided on the set of electrodes;
the supply port for introducing the specimen to the reaction part;
an attachment part for connecting the set of electrodes to a measurement display; and
a picking plate which extends to a side opposite from the attachment part with respect to the reaction part and has a picking part to be picked up or on which the picking part is formed.

2. The biosensor according to claim 1, wherein the picking plate is bent or curved in a cross-sectional direction.

3. The biosensor according to claim 1, wherein at least a part of the biosensor rises from a flat surface when being placed on the flat surface.

4. The biosensor according to claim 1, wherein the picking plate includes a fold-back line extending along a surface of the picking plate and is bent along the fold-back line.

5. The biosensor according to claim 4, wherein the supply port is located on a tip side of the picking plate relative to the fold-back line of the picking plate and is projected outward by bending the tip side of the picking plate along the fold-back line.

6. The biosensor according to claim 1, wherein the picking plate includes a through hole, into which the supply port is projected.

7. The biosensor according to claim 1, wherein a distance from the reaction part to a tip of the picking plate is longer than a distance from the reaction part to each end of the set of electrodes on an attachment part side.

8. The biosensor according to claim 1, further comprising a cover for covering the reaction part, wherein the picking plate is attached to the cover or the substrate.

9. The biosensor according to claim 1, wherein the set of electrodes are positioned between the substrate and the picking plate.

10. The biosensor according to claim 1, wherein the picking plate is engaged with an engaging member of the measurement display and is slid and detached from the measurement display by sliding the engaging member.

11. The biosensor according to claim 1, further comprising a position regulating system for regulating a position of the object from which a specimen is collected with respect to the supply port.

12. The biosensor according to claim 11, wherein the picking plate includes a through hole into which the supply port is projected and which constitutes the position regulating system.

13. The biosensor according to claim 12,
wherein the picking plate includes a fold-back line extending along a surface of the picking plate,
the supply port is projected outward by bending a tip side of the picking plate along the fold-back line, and
a peripheral part of the through hole forms a projected tip that is projected outward and constitutes the position regulating system.

14. The biosensor according to claim 13, wherein the supply port is located on a rear end side of the picking plate relative to the fold-back line of the picking plate and recedes to the rear end side relative to the projected tip by bending the tip side of the picking plate along the

15. The biosensor according to claim 11, comprising a cover for covering the reaction part, wherein the picking plate is attached to the cover or the substrate.

16. The biosensor according to claim 11, wherein the set of electrodes are positioned between the substrate and the picking plate.

17. The biosensor according to claim 15, wherein the set of electrodes are positioned between the substrate and the picking plate.
